(19) United States
(12) Patent Application Publication
(10) Pub. No.: US 2025/0156176 A1
(43) Pub. Date: May 15, 2025

(54) CONTROL DEVICE, CONTROL METHOD, AND NON-TRANSITORY STORAGE MEDIUM

(71) Applicant: TOYOTA JIDOSHA KABUSHIKI KAISHA, Toyota-shi (JP)

(72) Inventor: Katsuhiro Masuda, Gifu-ken (JP)

(73) Assignee: TOYOTA JIDOSHA KABUSHIKI KAISHA, Toyota-shi (JP)

(21) Appl. No.: 18/934,591

(22) Filed: Nov. 1, 2024

(30) Foreign Application Priority Data
Nov. 13, 2023 (JP) 2023-193075

(51) Int. Cl. G06F 8/65; G06F 8/61

(52) U.S. Cl. CPC G06F 8/65; G06F 8/63

(57) ABSTRACT

The OTA master that controls the HMI that displays the information regarding the software update of the in-vehicle device mounted on the vehicle displays, on the HMI, a permission reception image indicating that the permission reception operation for executing the installation is performed by the user of the vehicle before the installation is started, solely in a case of the first update among two kinds of software updates including the first update accompanied by the temporary stop of the function of the in-vehicle device in executing the installation of the update software and the second update accompanied by the temporary stop of the function of the in-vehicle device in executing the installation of the update software.

### CROSS-REFERENCE TO RELATED APPLICATION

This application claims priority to Japanese Patent Application No. 2023-193075 filed on Nov. 13, 2023, incorporated herein by reference in its entirety.

### BACKGROUND

### 1. Technical Field

The present disclosure relates to a control device, a control method, and a non-transitory storage medium that display information on a software update of an in-vehicle device mounted on a vehicle.

### 2. Description of Related Art

Various in-vehicle devices that operate by executing software are mounted on a vehicle. An over-the-air (OTA) technology is known in which software of the in-vehicle device is updated by software downloaded from outside of the vehicle via wireless communication. Japanese Unexamined Patent Application Publication No. 2022-163396 (JP 2022-163396 A) discloses an OTA technology for updating software of an in-vehicle device through three phases of downloading, installing, and activating update software. In the related art, user's approval is asked for before the start of each phase.

### SUMMARY

When a frequency of an inquiry for the approval is high, the user may feel annoyed.

A control device for solving the above issue includes a controller configured to control a display unit configured to display information on a software update of an in-vehicle device mounted on a vehicle. The controller is configured to, solely in a case of a first update among two kinds of software updates including the first update and a second update, before installation of update software on the in-vehicle device is started, cause the display unit to display an approval reception image showing that an approval operation performed by a user of the vehicle for executing the installation is received.

A control method for solving the above issue is a control method of controlling a display unit configured to display information on a software update of an in-vehicle device mounted on a vehicle. The control method includes causing, solely in a case of a first update among two kinds of software updates including the first update and a second update, before installation of update software on the in-vehicle device is started, the display unit to display an approval reception image showing that an approval operation performed by a user of the vehicle for executing the installation is received.

A non-transitory storage medium for solving the above issue is a non-transitory storage medium storing a program that is executable by a control device configured to control a display unit configured to display information on a software update of an in-vehicle device mounted on a vehicle. The program causes the control device to perform functions including causing, solely in a case of a first update among two kinds of software updates including the first update and a second update, before installation of update software on the in-vehicle device is started, the display unit to display an approval reception image showing that an approval operation performed by a user of the vehicle for executing the installation is received.

In the control device, the control method, and the non-transitory storage medium, the first update is a software update accompanied by a temporary stop of a function of the in-vehicle device during execution of the installation, and the second update is a software update accompanied by no temporary stop of the function of the in-vehicle device during the execution of the installation.

The control device, the control method, and the non-transitory storage medium have an effect of reducing the frequency of user's approval in the software update.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a control device and a vehicle according to a first embodiment;

FIG. 2 is a sequence diagram showing a process procedure of an installation phase;

FIG. 3 is a diagram showing a display example of an approval reception image;

FIG. 4 is a diagram showing a display example of a guide image; and

FIG. 5 is a sequence diagram showing a flow of processes related to display of an approval reception image in the second embodiment.

### DETAILED DESCRIPTION OF EMBODIMENTS

### First Embodiment

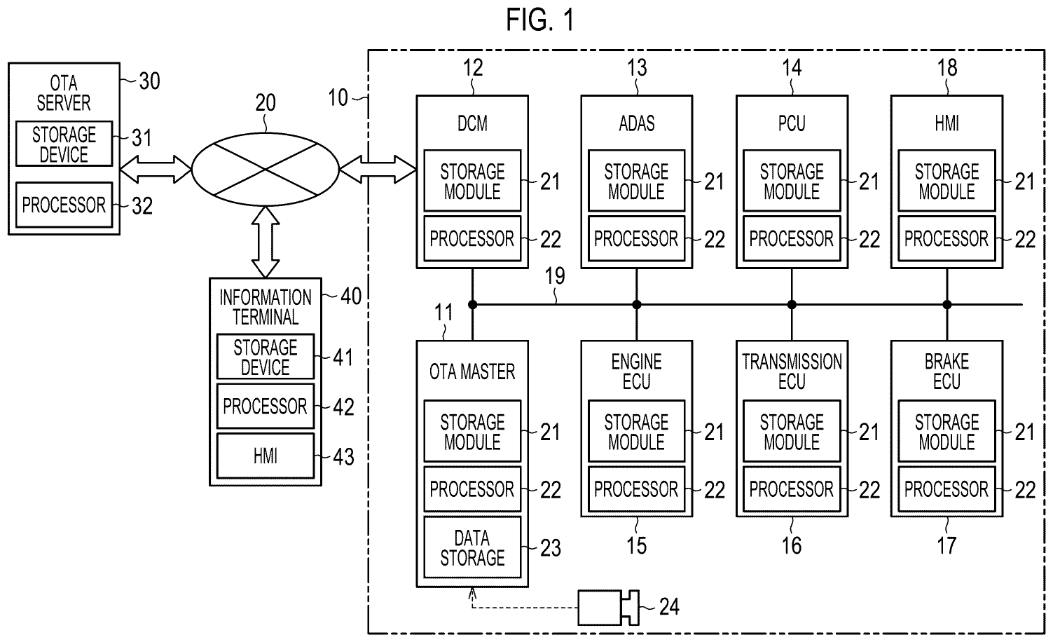

The first embodiment of a control device, a control method, and a storage medium will be described in detail with reference to FIGS. 1 to 4 below.

### Configurations of Control Device and Vehicle

As shown in FIG. 1, the vehicle 10 is equipped with an in-vehicle device, such as an OTA master 11, a DCM 12, an ADAS 13, a PCU 14, an engine ECU 15, a transmission ECU 16, a brake ECU 17, and an HMI 18. The in-vehicle devices are connected to each other such that communication is possible through the in-vehicle network 19. The OTA master 11 is in charge of managing the software update of the in-vehicle device including the OTA master 11. The DCM 12 is a data communication module that provides a wireless communication function with the outside of the vehicle through the mobile communication network 20. In the present embodiment, the DCM 12 functions to record the result of the self-diagnosis performed by each in-vehicle device of the vehicle 10 and transmit the result to a data center or the like outside the vehicle. The ADAS 13 is an advanced driving assistant system that provides advanced driving assistance functions, such as an automatic brake device and a quick start prevention device. The PCU 14 is a power control unit and is an in-vehicle device that performs power control in the vehicle. The engine ECU 15 is an electronic control unit for engine control. The transmission ECU 16 is an electronic control unit for transmission control. The brake ECU 17 is an electronic control unit for brake control. The HMI 18 is a human machine interface and includes an input device that receives an operation of the occupant and a display device that displays information to the occupant by an image or a voice. The HMI 18 may have a configuration including a navigation function that guides the traveling route and an entertainment function that reproduces music or video. Each of the in-vehicle devices has a storage module 21 in which software is stored and a processor 22 that executes the software. The OTA master 11 further has a data storage 23 that stores the update software acquired from the outside of the vehicle.

Further, a power switch 24 for switching the power on and the power off of the vehicle 10 is installed in the vehicle 10. The drive system of the vehicle 10 is started in response to switching from the power off to the power on, and is stopped in response to switching from the power on to the power off.

The vehicle 10 is connected to the OTA server 30 via the mobile communication network 20. The OTA server 30 is a server device that distributes update software for the in-vehicle device. The OTA server 30 has a storage device 31 that stores a program or data for distribution of update software, and a processor 32 that executes the program for distribution. The OTA server 30 can communicate with the information terminal 40 of the user of the vehicle 10 via the mobile communication network 20. Examples of the information terminal 40 include a smartphone. The information terminal 40 includes a storage device 41, a processor 42, and an HMI 43. The processor 42 reads and executes software stored in the storage device 41. The HMI 43 includes an input device that receives an operation of the user and a display device that displays information to the user. The software stored in the storage device 41 includes software that provides a function of confirming information on the vehicle 10 owned by the user, a remote operation, and the like.

### Outline of Software Update

Next, an outline of software update of the in-vehicle device in the vehicle 10 will be described. The in-vehicle device that is a target of the software update includes the OTA master 11, the DCM 12, the ADAS 13, the PCU 14, an engine ECU 15, a transmission ECU 16, a brake ECU 17, and the HMI 18. The software update is performed through a download phase, an installation phase, and an activation phase.

In the download phase, the update software is transmitted from the OTA server 30 to the vehicle 10. The OTA master 11 stores the update software received from the OTA server 30 in the data storage 23. The download phase includes a series of processes related to download, such as execution feasibility determination of download and verification of update data. The transmission of the update software from the OTA server 30 to the OTA master 11 may be performed by transmitting compressed data obtained by compressing the update software or by transmitting divided data obtained by dividing the update software or the compressed data. In addition, the update software of a plurality of the in-vehicle devices may be collectively transmitted.

In the installation phase, the update software is installed in the in-vehicle device to be updated. In the installation phase, the OTA master 11 writes the update software to the storage module 21 of the in-vehicle device to be updated. The installation phase includes a series of processes related to installation, such as execution feasibility determination of installation, transfer of update data, and verification of update software. In a case where the update data includes the update software itself, the OTA master 11 transfers 10 the update data to the in-vehicle device to be updated in the installation phase. When the update data includes the compressed data, the difference data, or the divided data of the update software, the generation process of the update software from the update data is performed. The generation process may be executed by the OTA master 11 or may be executed by the in-vehicle device to be updated. The update software can be generated by decompressing the compressed data and assembling the difference data or the divided data. Note that, at the time of completion of the installation phase, the update software is inactivated.

In the activation phase, the update software is activated, that is, the update software is activated in the in-vehicle device to be updated. The activation phase includes a series of processes related to activation, such as execution feasibility determination of activation, consistency check of the update software, and verification of the execution result of the activate.

### Process Procedure of Installation Phase

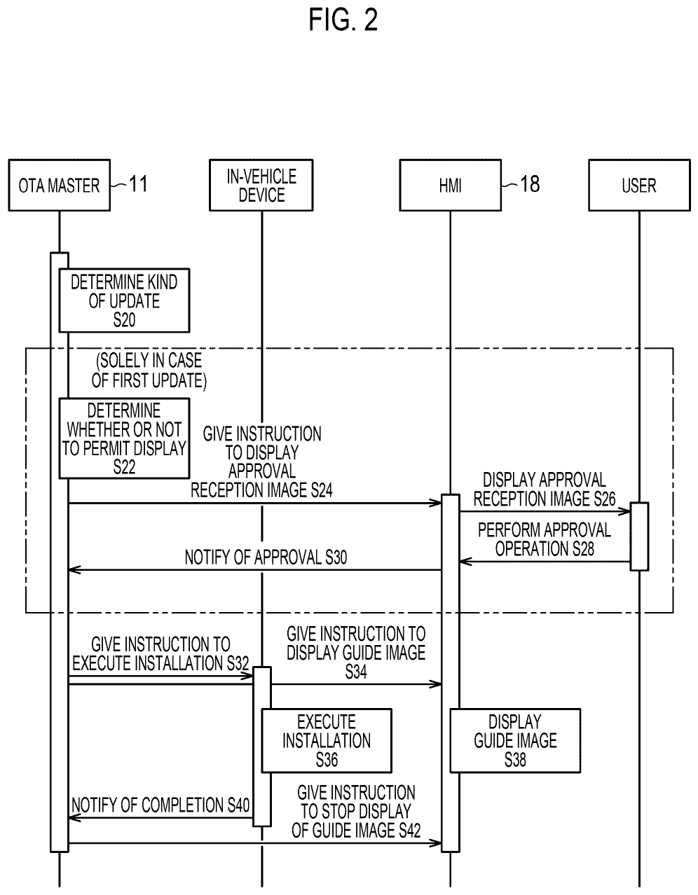

Subsequently, a process procedure of the installation phase will be described with reference to FIGS. 2 to 4.

The in-vehicle device that is a target of software update includes a device that is equipped with a single bank storage module 21 and a device that is equipped with a dual bank storage module 21. The storage module 21 of the single bank has solely one storage area for storing software executed by the processor 32. In the case of the in-vehicle device equipped with the single bank storage module 21, the software after update is written in the same storage area as the storage area in which the software before update is stored. Therefore, the execution of the installation may be accompanied by a temporary stop of the function of the in-vehicle device. In contrast, the storage module 21 of the dual bank has two storage areas. One of the two storage areas is inactivated, and the other is activated. The processor 22 reads and executes the software from the activated storage area. In the case of the in-vehicle device equipped with the dual bank storage module 21, the updated software is written to the inactivated storage area, that is, a storage area different from the storage area in which the software before the update is stored. Therefore, the installation can be executed while the software before the update is activated.

Due to such a hardware constraint, there is a case where the in-vehicle device in which the function is temporarily stopped during installation exists. In the present embodiment, the HMI 18 that provides the entertainment function is equipped with the single bank storage module 21. In contrast, the in-vehicle device that needs to maintain the function even during installation is equipped with the storage module 21 of the dual bank. Specifically, the OTA master 11, the DCM 12, the ADAS 13, the PCU 14, the engine ECU 15, the transmission ECU 16, and the brake ECU 17 are equipped with a dual bank storage module 21.

In the HMI 18 equipped with the single bank storage module 21, the installation may be executed without temporarily stopping the function depending on the kind of the software. For example, software update for adding a kind of user interface (UI) of the HMI 18 that can be selected by the user can be installed without temporarily stopping the function of the HMI 18.

In the following description, software update accompanied by the temporary stop of the function of the in-vehicle device in the execution of the installation is described as first update. In addition, software update that does not accompany the temporary stop of the function of the in-vehicle device in the execution of the installation is described as second update. Whether the software update is performed by the first update or the second update is decided depending on the kind of the in-vehicle device or the software. The campaign information distributed to each vehicle 10 by the OTA server 30 at the time of the software update includes update kind information indicating whether the software update this time is the first update or the second update.

As shown in FIG. 2, when the installation phase is started, the OTA master 11 executes an update kind determination to determine whether the software update this time is the first update or the second update (S20). In the present embodiment, the OTA master 11 performs the update kind determination based on the update kind information in the campaign information.

When the OTA master 11 determines that the update this time is the first update in S20, the OTA master 11 determines whether or not to display the approval reception image on the HMI 18 (S22). The approval reception image is an image indicating that an approval operation of the user to execute the installation is being received. For example, the OTA master 11 performs the feasibility determination based on the traveling status of the vehicle 10. Specifically, the OTA master 11 determines whether the vehicle 10 is traveling or is stopped based on the vehicle speed, the operation status of the brake, the shift position, and the like. Then, the OTA master 11 determines to permit the display of the approval reception image in a case where the vehicle 10 is stopped. In addition, the display permission of the approval reception image may be determined based on the position of the vehicle 10. For example, the OTA master 11 determines that the display of the approval reception image is permitted in a case where it is confirmed that the vehicle 10 is stopped at the parking place registered in advance. The position information of the vehicle 10 can be acquired from the HMI 18 that provides the navigation function. When the OTA master 11 determines that the display is permitted in S22, the OTA master 11 instructs the HMI 18 to display the approval reception image (S24). The HMI 18 displays the approval reception image in response to the instruction (S26).

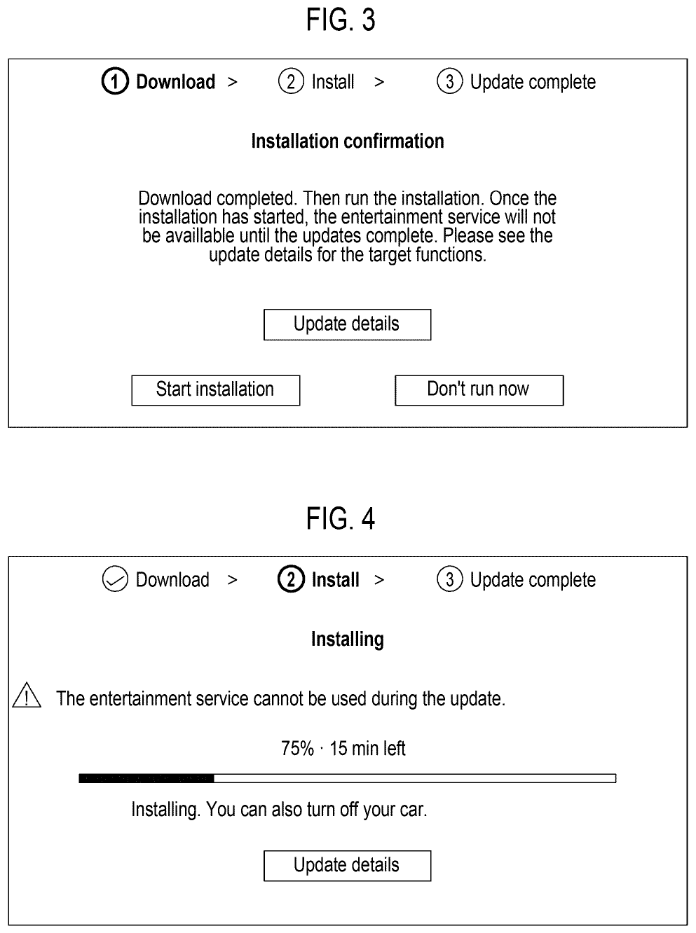

FIG. 3 shows a display example of the approval reception image. The approval reception image displays a button for selecting whether to start the installation or to perform the installation later. In addition, in the approval reception image, information indicating that the function of the in-vehicle device is temporarily stopped is displayed when the installation is started. For example, in the case of FIG. 3, the entertainment function provided by the HMI 18 is displayed as an example of the function that is temporarily stopped.

When the user performs the approval operation for installation on the HMI 18 on which the approval reception image is displayed (S28), the HMI 18 notifies the OTA master 11 that the approval operation is performed (S30). The OTA master 11 instructs the execution of installation in the in-vehicle device to be updated in response to the notification (S32). In addition, the OTA master 11 instructs the HMI 18 to display the guide image (S34). The in-vehicle device to be updated executes the installation in response to the instruction (S36). The HMI 18 displays the guide image in response to the instruction (S38). When the in-vehicle device that is a target of the software update by the first update is the HMI 18, the HMI 18 executes the display of the guide image in parallel with the installation.

FIG. 4 shows a display example of the guide image in the case of the first update. The guide image displays information indicating that the installation is being executed and information indicating a progress status of the installation. Further, the guide image in the case of the first update displays information indicating the content of the function of the in-vehicle device that is temporarily stopped with the execution of the installation. In the case of FIG. 4, the entertainment function provided by the HMI 18 is displayed as an example of the function that is temporarily stopped.

When the installation is completed, the in-vehicle device notifies the OTA master 11 of the completion of the installation (S40). The OTA master 11 instructs the HMI 18 to stop displaying the guide image in response to the notification. The HMI 18 stops displaying the guide image in response to the instruction. As described above, the installation phase is completed, and the process proceeds to the activation phase.

On the other hand, in a case where the OTA master 11 determines in S20 of FIG. 2 that the update this time is the second update, the processes of S22 to S30 are skipped, and the process of S32 is executed. Specifically, the OTA master 11 performs the instruction to execute the installation to the in-vehicle device (S32) and the instruction to display the guide image on the HMI 18 after the update kind determination (S22). The guide image to be displayed on the HMI 18 in this case is obtained by omitting the information indicating the content of the function of the in-vehicle device to be temporarily stopped from the guide image in the case of the first update shown in FIG. 4.

### Operations and Effects of Embodiment

In a case of the first update, the function of the in-vehicle device is temporarily unavailable when the installation is started. In such a case of the first update, the OTA master 11 causes the HMI 18 to display the approval reception image before the start of the installation. The approval reception image is an image indicating that the approval operation of the user of the vehicle 10 to execute the installation is received. Then, the OTA master 11 instructs the in-vehicle device to execute the installation in response to the user performing the approval operation of the installation. Therefore, the user is allowed to select a time when the temporary stop of the function of the in-vehicle device is acceptable, and the update software is installed.

In the case of the second update, the function of the in-vehicle device to be updated, and thus the function of the vehicle 10 can be maintained, and the installation can be executed. Therefore, in the case of the second update, even when the installation is executed, the function of the vehicle 10 does not change. In the second update, the OTA master 11 executes the installation without displaying the approval reception image to the HMI 18. Therefore, in the case of the second update, the installation is executed automatically even when the user does not approve the installation.

In the present embodiment, the OTA master 11 is a control device, and corresponds to a controller that controls a display unit that displays information on software update of the in-vehicle device mounted in the vehicle 10. The HMI 18 corresponds to a display unit that displays information on software update of the in-vehicle device mounted in the vehicle 10. Further, the OTA server 30 corresponds to a server outside the vehicle that distributes update software.

The present embodiment has the following effects.

(1) The OTA master 11 displays the approval reception image on the HMI 18 solely in the case of the first update accompanied by the temporary stop of the function of the in-vehicle device in the execution of the installation. Then, in a case of the second update without the temporary stop of the function of the in-vehicle device in the execution of the installation, the OTA master 11 automatically executes the installation without the user's approval. Therefore, in a case where the installation is accompanied by the temporary stop of the function, the user can select when to execute the installation, and in a case where the installation is not accompanied by the temporary stop of the function, the installation can be executed without obtaining the user's approval. Therefore, in the present embodiment, there is an effect of reducing the frequency of user's approval in the software update.

(2) The OTA master 11 performs an update kind determination of whether the software update is the first update or the second update. Specifically, the OTA master 11 performs the update kind determination based on the update kind information acquired from the OTA server 30 outside the vehicle that distributes the update software. Then, the OTA master 11 decides the process procedure of the installation phase by itself based on the determination result of the update kind. Therefore, the OTA master 11 can switch the process procedure of the installation phase without relying on the instruction from the outside, in the case of the first update and in the case of the second update.

(3) The OTA master 11 causes the in-vehicle device to execute the installation of the update software without waiting for the user's approval operation in a case where the software update is the second update. In a case where the temporary stop of the function of the in-vehicle device is not performed, the installation is automatically executed, so that the burden on the user is reduced.

(4) The OTA master 11 causes the in-vehicle device to execute the installation of the update software in response to the user performing the approval operation when the software update is the first update. Therefore, the user can execute the installation by selecting a time when the user can allow the temporary stop of the function of the in-vehicle device.

(5) When the software update is the first update, the OTA master 11 causes the HMI 18 to display information indicating the content of the function of the in-vehicle device that is temporarily stopped during the execution of the installation. Therefore, the user can easily understand that the function of the in-vehicle device is temporarily stopped during the execution of the installation.

(6) The OTA master 11 displays the approval reception image on the HMI 18 at a time decided by the traveling status of the vehicle 10 or the position of the vehicle 10 after the download of the update software is completed. Therefore, the approval reception image can be displayed in a status where the user is easy to confirm or operate the image of the HMI 18, such as when the vehicle 10 is parked.

### Second Embodiment

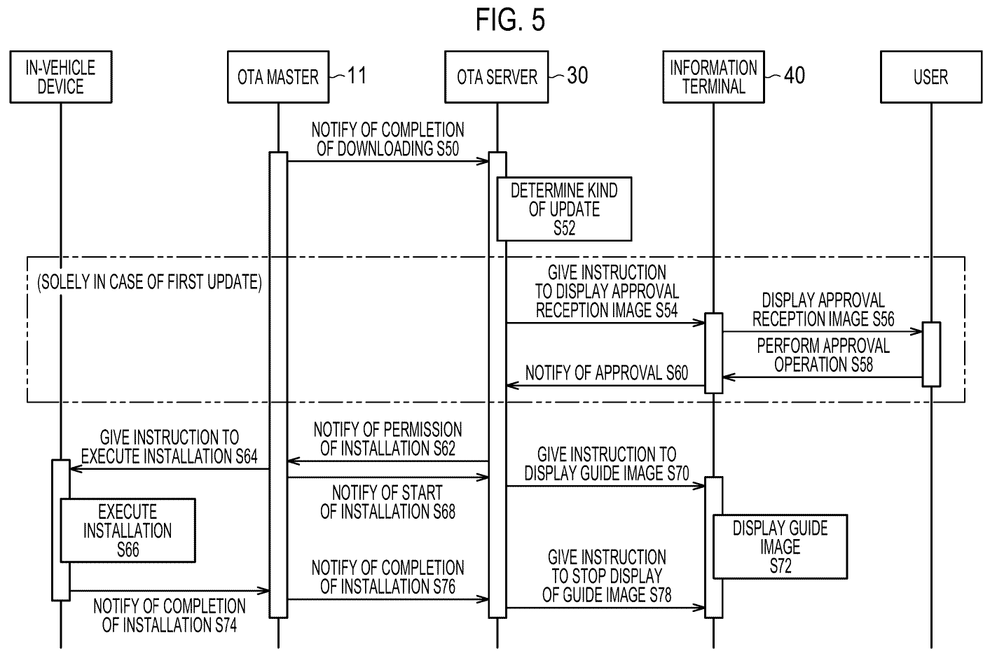

Next, a second embodiment of the control device, the control method, and the storage medium will be described in detail with reference to FIG. 5. Note that in the present embodiment, the same reference signs are given to the configurations common to the embodiment described above, and detailed description thereof will be omitted.

In the first embodiment, the OTA master 11 mounted in the same vehicle 10 performs the display control of the information regarding the software update on the HMI 18 installed in the vehicle 10. In the present embodiment, the information regarding the software update is displayed on the information terminal 40 owned by the user of the vehicle 10. The OTA server 30 of the data center performs display control of the information terminal 40.

When the download of the update software is completed, the OTA master 11 of the vehicle 10 notifies the OTA server 30 of the completion (S50). The OTA server 30 executes the update kind determination in response to the notification (S52). The OTA server 30 executes the update kind determination based on, for example, the campaign information distributed to the vehicle 10 by the OTA server 30.

When the OTA server 30 determines that the software update this time is the first update, the OTA server 30 instructs the information terminal 40 owned by the user of the vehicle 10 to display the approval reception image (S54). The information terminal 40 displays the approval reception image in response to the instruction (S56). The approval reception image displayed on the information terminal 40 is the same as that in FIG. 3. Thereafter, in a case where the user performs the approval operation of the installation (S58), the information terminal 40 notifies the OTA server 30 that the installation is approved (S60). The OTA server 30 notifies the OTA master 11 of the vehicle 10 that the execution of the installation is permitted in response to the notification (S62). The OTA master 11 instructs the execution of installation of the update on the in-vehicle device to be updated in response to the notification (S64). The in-vehicle device starts the installation in response to the instruction (S66).

Next, the OTA master 11 notifies the OTA server 30 that the installation has been started (S68). The OTA server 30 instructs the information terminal 40 to display the guide image in response to the notification (S70). The information terminal 40 displays the guide image in response to the instruction (S72). The content of the guide image displayed on the information terminal 40 at this time is the same as that of FIG. 4.

When the installation is completed, the in-vehicle device notifies the OTA server 30 that the installation is completed via the OTA master 11 (S74, S76). The OTA server 30 instructs the information terminal 40 to stop displaying the guide image in response to the notification (S78). The information terminal 40 stops displaying the guide image in response to the instruction. As a result, the process of the installation phase is completed, and the process proceeds to the activation phase.

In contrast, when the OTA server 30 determines in S52 of FIG. 5 that the update this time is the second update, the OTA server 30 skips the processes of S54 to S60 and notifies the OTA master 11 that the execution of the installation is permitted (S62). Then, the process of the installation phase after S62 is performed in the same manner as in the case of the first update.

The control device, the control method, and the storage medium according to the present embodiment achieve the same operation and effect as those of the first embodiment. In the present embodiment, the OTA server 30 corresponds to the controller and the control device, and the information terminal 40 corresponds to the display unit.

### OTHER EMBODIMENTS

The embodiment described above can be modified and implemented as follows. The present embodiment and the following modification examples can be carried out in combination with each other within a technically consistent range.

The OTA master 11 in the first embodiment decides the time to display the approval reception image on the HMI 18 based on the traveling status and the position of the vehicle 10. The display timing of the approval reception image may be decided in another aspect. For example, the approval reception image may be displayed in response to the completion of the download.

Even in the case of the second update, the setting may be switched as to whether or not the user's approval of the installation is executed. In a case where the user can switch the setting, the system can respond to the user's request to reduce the frequency of the user approval and the user's request to want to confirm the progress of the software update in detail. In addition, in some countries or regions, the law may be established to require the user's approval to be obtained for the execution of the installation regardless of whether the installation is the first update or the second update. In addition, the necessity of obtaining a user's approval when the installation is executed may be changed due to the amendment of the regulation. In a case where the setting switching is executable by the manufacturer or the dealer of the vehicle 10, it is easy to cope with the difference in the regulations between the countries or regions and the amendment of the regulations.

The display control of the HMI 18 of the vehicle 10 by the OTA master 11 in the first embodiment and the display control of the information terminal 40 by the OTA server 30 in the second embodiment may be performed. In this case, both the OTA master 11 and the OTA server 30 correspond to the control device. Both the HMI 18 of the vehicle 10 and the information terminal 40 correspond to the display device. The installation in the first update in this case is permitted to be executed by the approval operation performed by the user on any one of the HMI 18 and the information terminal 40.

In the approval reception image of FIG. 3 or the guide image of FIG. 4, information indicating solely that the function of the in-vehicle device is temporarily stopped in association with the execution of the installation may be displayed instead of information indicating the specific content of the function to be temporarily stopped. Also in this case, the user is unlikely to feel uneasy or distrustful because the cause of the unavailability of the function of the vehicle device can be estimated to be the installation.

The display example of each image shown in FIGS. 3 and 4 was configured to display information in the image using characters. Information may be displayed using a method of expression other than characters, such as a still image or a moving image, in the images.

Information about the temporary stop of the function of the in-vehicle device accompanying the execution of the installation may not be displayed on the guide image in the case of the first update. In this case, the display content of the guide image in both the first update and the second update may be common. In addition, in both the first update and the second update, the display of the guide image during the execution of the installation may not be displayed.

In the first embodiment, the OTA master 11 that manages the software update performs the display control of the information regarding the software update. Another in-vehicle device may execute management of software update and display control of information regarding the software update.

The display control of the HMI 18 of the vehicle 10 in the first embodiment may be executed by the OTA server 30. In addition, the OTA master 11 may execute the display control of the information terminal 40 in the second embodiment. Further, the in-vehicle device that is the target of the software update may be configured to perform display control of information regarding the software update.

The update kind determination in S20 of FIG. 2 may be executed before the start of the installation phase. For example, the OTA master 11 may execute the update kind determination at the point in time when the campaign information is received from the OTA server 30.

The update kind determination of S20 in FIG. 2 may be performed in another aspect different from the above-described embodiment. For example, the update kind determination can be made in the following aspect. The in-vehicle device that performs the software update in each of the first update and the second update and the classification information on the kind of software are stored in advance in the storage module 21 of the OTA master 11. When the software is updated, the OTA master 11 acquires the kind of the in-vehicle device or software to be updated from the campaign information or the in-vehicle device to be updated. Then, the OTA master 11 determines whether the acquired kind is classified into the first update or the second update with reference to the classification information stored in the storage module 21. The update kind determination executed by the OTA server 30 in S52 of FIG. 5 can also be executed in the same manner in another aspect.

The control device and the controller may be configured as a circuit including one or more processors that operate in accordance with a computer program, one or more dedicated hardware circuits that execute at least a part of various processes, dedicated hardware, or a combination thereof. Examples of the dedicated hardware include an application-specific integrated circuit (ASIC) that is an integrated circuit for a specific application. The processor includes a CPU and a memory, such as a RAM and a ROM, and the memory stores program code or an instruction configured to cause the CPU to execute process. The memory, that is, the storage medium includes any available medium that can be accessed by a general-purpose or dedicated computer.

The expression “at least one” used in the present specification means “one or more” of desired options. As an example, the expression “at least one” used in the present specification means “solely one option” or “both options” in a case where the number of options is two. As another example, the expression “at least one” used in the present specification means “solely one option” or “a combination of two or more options” when the number of options is three or more.

What is claimed is:

1. A control device comprising a controller configured to control a display unit configured to display information on a software update of an in-vehicle device mounted on a vehicle, wherein:
the controller is configured to, solely in a case of a first update among two kinds of software updates including the first update and a second update, before installation of update software on the in-vehicle device is started, cause the display unit to display an approval reception image showing that an approval operation performed by a user of the vehicle for executing the installation is received; and
the first update is a software update accompanied by a temporary stop of a function of the in-vehicle device during execution of the installation, and the second update is a software update accompanied by no temporary stop of the function of the in-vehicle device during the execution of the installation.

2. The control device according to claim 1, wherein the controller is configured to, in a case where the software update is the first update, cause the display unit to display at least one of information indicating that the function of the in-vehicle device is temporarily stopped during the execution of the installation and information indicating a content of the function of the in-vehicle device that is temporarily stopped during the execution of the installation.

3. The control device according to claim 1, wherein the controller is configured to, after downloading the update software is completed, cause the display unit to display the approval reception image at a time decided based on at least one of a traveling status of the vehicle and a position of the vehicle.

4. A control method of controlling a display unit configured to display information on a software update of an in-vehicle device mounted on a vehicle, the control method comprising causing, solely in a case of a first update among two kinds of software updates including the first update and a second update, before installation of update software on the in-vehicle device is started, the display unit to display an approval reception image showing that an approval operation performed by a user of the vehicle for executing the installation is received, wherein the first update is a software update accompanied by a temporary stop of a function of the in-vehicle device during execution of the installation, and the second update is a software update accompanied by no temporary stop of the function of the in-vehicle device during the execution of the installation.

5. A non-transitory storage medium storing a program that is executable by a control device configured to control a display unit configured to display information on a software update of an in-vehicle device mounted on a vehicle and that causes the control device to perform functions comprising causing, solely in a case of a first update among two kinds of software updates including the first update and a second update, before installation of update software on the in-vehicle device is started, the display unit to display an approval reception image showing that an approval operation performed by a user of the vehicle for executing the installation is received, wherein the first update is a software update accompanied by a temporary stop of a function of the in-vehicle device during execution of the installation, and the second update is a software update accompanied by no temporary stop of the function of the in-vehicle device during the execution of the installation.
